(19) United States
(12) Patent Application Publication
(10) Pub. No.: US 2025/0260883 A1
(43) Pub. Date: Aug. 14, 2025

(54) SUBTITLE BASED CONTEXTUAL TV PROGRAM SUMMARIZATION

(71) Applicant: GOOGLE LLC, Mountain View, CA (US)

(72) Inventor: Sambit Padhi, Bangalore (IN)

(21) Appl. No.: 18/436,815

(22) Filed: Feb. 8, 2024

(51) Int. Cl. H04N 21/854; G06F 40/40; H04N 21/44; H04N 21/472; H04N 21/482; H04N 21/488

(52) U.S. Cl. CPC H04N 21/854; G06F 40/40; H04N 21/44008; H04N 21/47217; H04N 21/482; H04N 21/4884

(57) ABSTRACT

A device may initiate display of a media content item on a user interface displayed on a display device, the user interface including a user interface (UI) element. In response to a selection of the UI element, a device may pause playback of the media content item. A device may obtain subtitle data for a portion of the media content item. A device may generate a prompt request with a request to generate a textual summary by a machine-learning (ML) model using the subtitle data. A device may receive, from the ML model, a prompt response that includes the textual summary. A device may display the textual summary on the user interface.

### BACKGROUND

Users might be confused about the recent sequence of events in a television program (e.g., a movie, show, etc.) or they may want a summary before continuing with the playback of a television program. Some streaming platforms may provide a sequence of scenes to provide a recap of what previously happened in a series. In some examples, a user may manually scroll through a program's timeline to view previous content.

### SUMMARY

In some aspects, the techniques described herein relate to a method including: initiating display of a media content item on a user interface displayed on a display device, the user interface including a user interface (UI) element; in response to a selection of the UI element, obtaining subtitle data for a portion of the media content item; generating a prompt request with a request to generate a textual summary by a machine-learning (ML) model using the subtitle data; receiving, from the ML model, a prompt response that includes the textual summary; and displaying a UI object with the textual summary on the user interface.

In some aspects, the techniques described herein relate to a display device including: at least one processor; and a non-transitory computer-readable medium storing executable instructions that when executed by the at least one processor cause the at least one processor to: initiate display of a media content item on a user interface displayed on a display device, the user interface including a user interface (UI) element; in response to a selection of the UI element, obtain subtitle data for a portion of the media content item; generate a prompt request with a request to generate a textual summary by a machine-learning (ML) model using the subtitle data; receive, from the ML model, a prompt response that includes the textual summary; and display a UI object with the textual summary on the user interface.

In some aspects, the techniques described herein relate to a non-transitory computer-readable medium storing executable instructions that when executed by at least one processor cause the at least one processor to execute operations, the operations including: initiating display of a media content item on a user interface displayed on a display device, the user interface including a user interface (UI) element; in response to a selection of the UI element, obtaining subtitle data for a portion of the media content item; generating a prompt request with a request to generate a textual summary by a machine-learning (ML) model using the subtitle data; receiving, from the ML model, a prompt response that includes the textual summary; and displaying a UI object with the textual summary on the user interface.

The details of one or more implementations are set forth in the accompanying drawings and the description below. Other features will be apparent from the description and drawings, and from the claims.

### BRIEF DESCRIPTION OF THE DRA WINGS

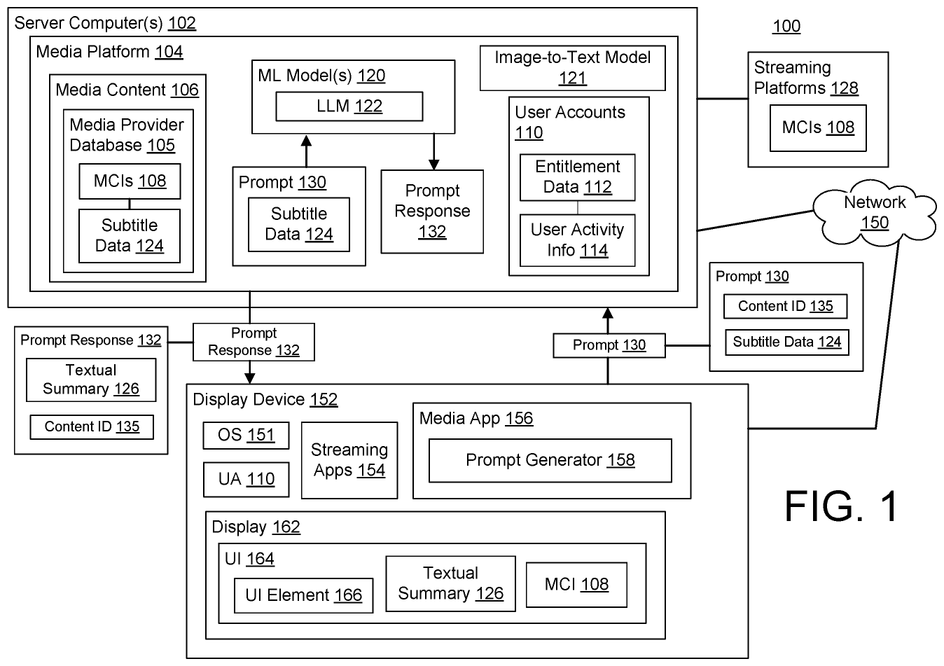

FIG. 1 illustrates a streaming system that uses a machine-learning model to generate a textual summary for at least a portion of a media content item according to an aspect.

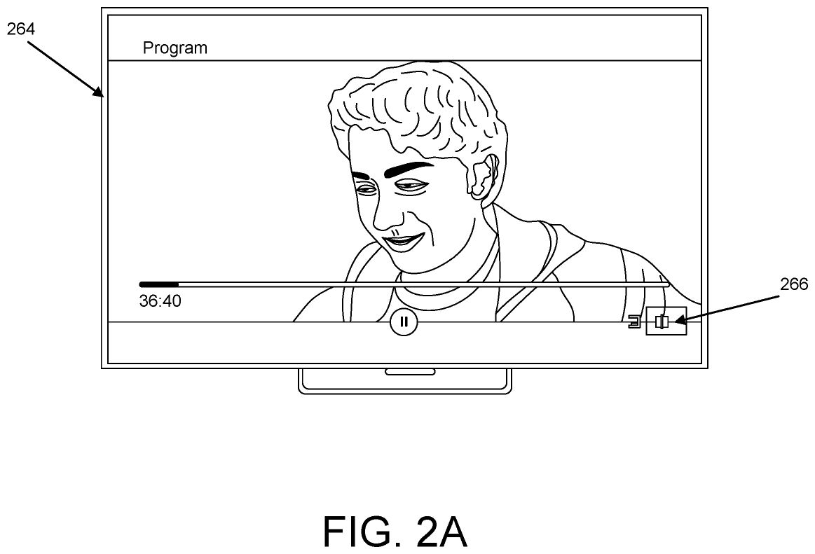

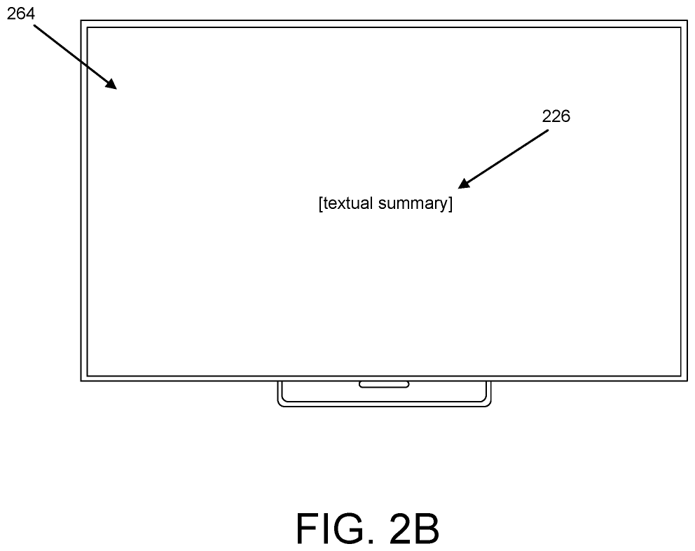

FIGS. 2A and 2B illustrate example user interfaces for generating and displaying textual summaries of portions of media content items according to an aspect.

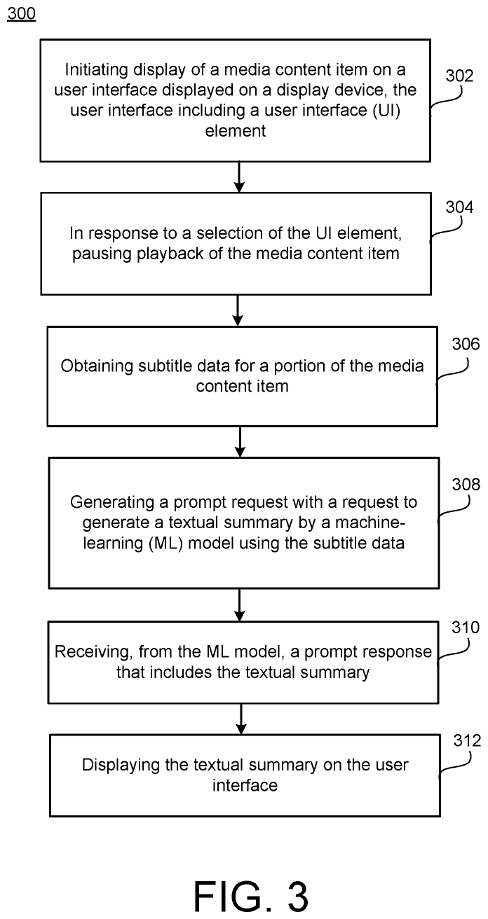

FIG. 3 is a flowchart depicting example operations of generating and displaying textual summaries using a machine-learning model according to an aspect.

### DETAILED DESCRIPTION

This disclosure relates to a streaming system that includes a large language model (LLM) to generate a summary (e.g., a short summary) of the recent sequence of events in a media content item (e.g., a television program such as a show or movie). In response to selection of a user interface (UI) element (e.g., clicking a button) on a user interface, the streaming system may obtain subtitle data for a period of time (e.g., last two minutes, last five minutes, last ten minutes, etc.) and generate a prompt with a request to generate a summary using the subtitle data. The streaming system may transmit the prompt to the LLM. The streaming system may receive a prompt response that includes the summary generated by the LLM, and the streaming system provides a UI object with the summary for display on the user interface. In some examples, the streaming system may operate with the LLM to generate and display personalized program descriptions based on the user's watch state (e.g., watch history).

The system may increase the performance of a display device (e.g., a television device or other type of user device) by reducing latency and/or buffering issues caused by repeatedly navigating back and/or forth through a timeline of a media content item to view past content. Conventionally, a user may move a UI element (e.g., a skip forward button, a skip backward button, a timeline slider, etc.) to navigate to different parts of the media content item, but navigating back and forward in the item's timeline may cause latency and/or buffering issues because repeatedly moving a current playback point may cause the display of content to be delayed due to network latency.

For instance, when moving to a new playback position, the display device starts to download the content and buffers it until there is enough content in the buffer to initiate playback. The resulting gap in playback in itself reduces the user experience, but significantly this delays the time when a user can start to assess whether the new playback position is a desired playback position. If it is not a desired playback position, the user will move a UI element (e.g., a skip forward button, a skip backward button, a timeline slider, etc.) to navigate to a further different part of the media content item, where buffering will cause a further gap in playback and a further delay to the time when a user can start to assess whether the new playback position is the desired playback position. This can occur multiple times in short succession. In addition to being inconvenient to the user, the buffering mechanism at the display device conventionally is complex in order to accommodate repeated changes in playback position for short periods of time, especially if content is to remain buffered in case of navigation to a position where the buffered content may again be played (e.g. in the case of skipping backwards in the media content). However, programmatically generating summaries using an LLM may efficiently provide summaries of past content while avoiding latency and/or buffering issues otherwise caused by manually navigating back and/or forth through the item's timeline and may also avoid the need for complex buffering mechanisms.

A media application, executable by a display device, renders a user interface that identifies a plurality of media content items that are available for streaming on the display device. A media content item may be a show, program, movie, etc. Selection of a media content item from the application's user interface causes the media content item to be streamed on the display device. For example, in response to selection of a media content item from the user interface, the media application may initiate playback of the media content item. In some examples, the user interface includes a UI element, which, when selected, causes the media application to obtain subtitle data and generate a prompt with a request to generate a summary using the subtitle data. In some examples, the UI element includes an input field that enables the user to enter a natural language query about the media content item. For example, the user can ask questions about the media content item via the input field, and the user interface may display textual responses, generated by the LLM, on the user interface. In some examples, the streaming system may obtain one or more signals about an underlying user account (e.g., biographic data such as age and/or gender, user interests, user preferences, etc.), and the prompt may include information generalized information about the user, where the LLM generates a personalized textual summary.

The media application may transmit the prompt to an LLM that is trained to generate summaries in media content items. In some examples, the LLM may be stored on a server computer. In some examples, the LLM may be stored on the display device. In some examples, the display device is a virtual reality (VR) device or an augmented reality (AR) device, and the LLM is stored on a user device (e.g., the user's smartphone), which is connected to the VR device or the AR device. In response to the prompt, the LLM may generate a textual description (e.g., a summary) using the subtitle data. In some examples, the LLM is a conventional large language model (e.g., based on a transformer architecture), adapted to generate text in response to a text prompt provided as input. Such LLMs are trained on a large corpus of publicly available text, e.g., content from public databases and websites. In some examples, the LLM is configured to generate a textual response, which serves as a summary for the last period of time (e.g., last two minutes, last five minutes, etc.). In some examples, the LLM is a specially trained language model (e.g., trained using media content available on one or more streaming platforms) that can generate summaries using subtitle data.

The LLM generates and transmits a prompt response to the media application or the media platform. The prompt response includes the summary generated by the LLM. In response to receiving the prompt response or the summary, the media application may display the summary on the user interface. These and other features are further described with reference to the figures.

FIG. 1 illustrates a system 100 that generates a textual summary 126 for a media content item 108 using a ML model 120 and subtitle data 124. In some examples, the ML model 120 uses the subtitle data 124 as an input and generates the textual summary 126 as an output. In some examples, the system 100 generates a textual summary 126 based on textual data generated by an image-to-text model 121 (e.g., a ML model 120) inputted with image frames for at least a portion of a media content item 108. In some examples, the ML model 120 uses the textual data generated by the image-to-text model 121 as an input and generates the textual summary 126 as an output. In some examples, the ML model 120 generates the textual summary 126 based on the subtitle data 124 and the textual data generated by the image-to-text model 121.

The system 100 may increase the performance of a display device 152 by reducing latency and/or buffering issues caused by manually navigating through a timeline of a media content item 108 to view previously displayed content to determine what happened in a movie or a show. For example, conventionally, a user may move a UI element (e.g., a skip forward button, a skip backward button, a timeline slider) to navigate to different parts of the media content item 108, but navigating back and forward in the item's timeline may cause latency and/or buffering issues because repeatedly moving a current playback point in the timeline may cause the display of content to be delayed due to network latency. However, using a ML model 120 to generate a textual summary 126 of at least a portion of the media content item 108 using subtitle data 124 (and/or textual data generated by the image-to-text model 121) may efficiently render a media content item 108 while avoiding latency and/or buffering issues caused by manually navigating back and/or forth through the item's timeline.

The system 100 includes a media platform 104 executable by one or more server computers 102 and a media application 156 executable by a display device 152. The media platform 104 may be a server-based television platform. In some examples, the media application 156 is (or is a subcomponent of) an operating system 151 of the display device 152. In some examples, the media application 156 is a native application (e.g., a standalone native application), which is preinstalled on the display device 152 or downloaded to the display device 152 from a digital media store (e.g., play store, application store, etc.). The media application 156 may communicate with the media platform 104 to identify media content 106 that is available for streaming to the display device 152. The media content 106 includes a plurality of media content items 108. In some examples, the media content 106 includes media content items 108 that are stored on the media platform 104 and streamed from the media platform 104 to the media application 156. In some examples, the media content 106 includes media content items 108 that are stored on one or more (other) streaming platforms 128 and streamed from the streaming platforms 128 to their respective streaming applications 154.

In some examples, the media application 156 is a media aggregator application that determines which providers (e.g., streaming platforms 128, associated streaming applications 154) the user has access rights to, and then identifies media content items 108, across those providers, in the user interface 164 for selection and playback. For example, the media application 156 (e.g., in conjunction with the media platform 104) may aggregate (e.g., combine, assemble, collect, etc.) information about media content 106 available for viewing (e.g., streaming) from multiple streaming platforms 128 and present the information in the user interface 164 (e.g., a single, unified user interface) so that a user can identify and/or search media content 106 across different streaming platforms (e.g., without having to search within each streaming application 154). In some examples, the media content 106 is referred to as media content items 108 (e.g., individual programs offered by streaming platforms 128). For example, each media content item 108 may be a program (e.g., a television show, a movie, a live broadcast, etc.) from the media platform 104 or another streaming platform 128. Instead of searching for media content items 108 on a first streaming application and media content items 108 on a second streaming application, the media application 156 may combine the media content items 108 together in one interface (e.g., user interface 164) so that a user can search across multiple streaming platforms 128 at once.

In some examples, a media content item 108 may correspond to a digital video file, which may be stored on the streaming platforms 128 (including the media platform 104) and/or the display device 152. In some examples, the media platform 104 is also considered a streaming platform 128, which may store and provide digital video files for streaming or downloading. The digital video file may include video and/or audio data that corresponds to a particular media content item 108. In some examples, the media platform 104 is configured to communicate with the streaming platforms 128 to identify which media content 106 is available on the streaming platforms 128 and may update a media provider database 105 to identify the media content items 108 offered by the streaming platforms 128.

For example, the media platform 104 may communicate, over a network 150, with the streaming platforms 128 to identify which media content 106 is available to be streamed by display devices 152 and update a media provider database 105. The media platform 104 may identify a set or multiple sets of media content items 108 (e.g., across the various streaming platforms 128) as recommendations to a user of the media application 156. In some examples, the media platform 104 may determine whether the user of the media application 156 has rights (e.g., stored as entitlement data 112) to stream media content 106 from one or more of the streaming platforms 128 (e.g., whether the user has subscribed to access media content 106 from the streaming platform(s) 128), and, if so, may include those media content items 108 as candidates in a selection (e.g., ranking) mechanism to potentially be displayed in the user interface 164 of the media application 156.

The media application 156 includes a user interface 164 that identifies media content items 108 for selection and playback on the display device 152. In response to selection of a media content item 108, the media application 156 may initiate playback of the media content item 108 on a display 162 of the display device 152. In some examples, in response to selection of the media content item 108, the media platform 104 streams the media content item 108 to the media application 156, which causes the media application 156 to display the media content item 108 on the display 162. In some examples, in response to selection of the media content item 108 from the user interface 164 of the media application 156, the media application 156 causes the content's underlying streaming application 156 to playback the media content item 108.

In some examples, selection of a media content item 108 from the user interface 164 may cause the media application 156 to launch a streaming application 154 (e.g., using a content deep link) associated with the streaming application 154. In some examples, selection of a media content item 108 from the user interface 164 causes the media application 156 to render another user interface (e.g., item's landing page), and further selection of the media content item 108 from the item's landing page causes the media application 156 to launch the underlying streaming application 154. In some examples, the media content item 108 may be associated with a specific provider in which the media content item 108 is streamed from a streaming platform 128 (e.g., the media platform 104 itself or another streaming platform 128). In some examples, the user can control the playback of the media content item 108 from the corresponding streaming application 154.

A content deep link, corresponding to a media content item 108, may be an identifier that identifies the location of the media content item 108 in the streaming application 154. The media application 156 may transfer the content deep link to the corresponding streaming application 154. In some examples, the content deep link identifies a specific landing page (e.g., an interface) within the streaming application 154 that corresponds to the media content item 108. In some examples, the content deep link is an operating system intent. In some examples, the content deep link is a uniform resource locator (URL). In some examples, the content deep link includes a URL format.

Streaming (or playback) of the media content item 108 may refer to the transmission of the contents of a video file (e.g., media assets) from a streaming platform 128 or the media platform 104 to the display device 152 that displays the contents of the video file. In some examples, streaming (or playback) of the media content item 108 may refer to a continuous video stream that is transferred from one place to another place in which a received portion of the video stream is displayed while waiting for other portions of the video stream to be transferred. In some examples, after the media content item 108 is published on the media platform 104 (e.g., is live), the display device 152 may stream or download the contents of the video file.

In some examples, the user interface 164 may identify a plurality of media content items 108, which may be selected by the media platform 104 from the media provider database 105 based at least in part on information representing the user's interests and activities (e.g., the user's search queries, search results, previous watch history, purchase history, application usage history, application installation history, user actions on the network-connected display device, physical activities of the user, etc.). In some examples, the media application 156 may be associated with a user account 110, and the user account 110 may store the information representing the user's interests and activities (e.g., user activity information 114), and the media platform 104 may use this information to select and present the media content items 108 in the user interface 164. In some examples, the media content items 108 may be organized as a plurality of clusters based on one or more categories, such as content type (e.g., “Action Movies”), viewing history (e.g., “Because You watched Movie ABC”), release time (e.g., “Trending”), and the like. In some examples, the media content items 108 provided by different streaming platforms 128 (e.g., action movies from two different streaming platforms 128) can be recommended in the same cluster. In some examples, the user interface 164 may include tabbed interfaces, where one of the tabbed interfaces includes personalized media content that is organized as a plurality of clusters based on one or more categories, such as release time (e.g., “This Week,” “Next week,” “Next Month,” etc.), user action and user application interaction, native app usage (e.g., items that are “From App ABC”), etc.

It is noted that a user of the media application 156 may be provided with controls allowing the user to make an election as to both if and when the system 100 may enable the collection of information representing the user's interests and activities. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user of the media application 156 may have control over what information is collected about the user, how that information is used, and what information is provided to the user and/or to the server computer 102.

The user interface 164 includes a UI element 166, which, when selected, causes the system 100 to initiate the generation and display of a textual summary 126 of a media content item 108. In some examples, the UI element 166 is displayed when a particular media content item 108 is currently being played back. In some examples, the UI element 166 is a selectable icon or button. In some examples, the UI element 166 is overlaid on video content of the media content item 108. In some examples, the UI element 166 is included as part of a menu item.

In some examples, the media application 156 displays an interface for receiving a natural language query about the media content item 108. For example, the user may enter “provide a summary of the last two minutes.” In some examples, the interface includes an input field that enables the user to submit a natural language query (e.g., “skip to the scene that includes a certain actor in a fighting scene”). In some examples, a user may enter text into the input field to define the natural language query. In some examples, the interface may be a user interface configured to receive text via a voice command and may display the text of the voice command in the input field. The natural language query may be text that identifies a particular previous period of time to receive a textual summary 126. In some examples, the natural language query may be any type of query about the underlying media content item 108.

The media application 156 includes a prompt generator 158 configured to generate a prompt 130 to be used as an input to the ML model 120. In response to the selection of the UI element 166, the prompt generator 158 may generate the prompt 130. In some examples, the prompt generator 158 may obtain subtitle data 124 for a period of time and include the subtitle data 124. In some examples, the prompt 130 includes the natural language query. In some examples, the prompt 130 includes the textual data generated by the text-to-image model. In some examples, the period of time is a predetermined period of time that is determined by the media platform 104. In some examples, the period of time is set by the user, e.g., the last two minutes, the last five minutes, the last ten minutes, etc. In other words, the subtitle data 124 may be the subtitle data for a portion of the media content item 108. In some examples, the prompt generator 158 may obtain the subtitle data 124 from the media application 156 (e.g., from a video file stored on the display device 152). In some examples, the prompt generator 158 may obtain the subtitle data 124 from the media platform 104.

In some examples, the media application 156 may include (or communicate with) an image-to-text model 121. In some examples, the media application 156 or the media platform 104 may provide image frames of the media content item 108 for the period of time and receive the textual data about the image frames. In some examples, the prompt generator 158 may generate the prompt 130 with the textual data from the image-to-text model 121.

In some examples, the prompt 130 may include a content identifier 135 of the media content item 108. The content identifier 135 may uniquely identify the media content item 108 on the media platform 104 and/or the streaming platform 128. In response to selection of the UI element 166, the prompt generator 158 may generate a prompt 130 with a request to generate a textual summary 126 for a portion of the media content item 108 using the subtitle data 124 included in the prompt 130. In some examples, the prompt 130 includes an instruction to generate a textual summary 126 for a portion of the media content item, which can be identifiable by a starting time (e.g., beginning of the period of time) and an ending time (e.g., the current point in the playback or the time when the user selected the UI element 166). In some examples, the prompt generator 158 is stored at the client device, e.g., the display device 152. In some examples, the prompt generator 158 is included on the media platform 104 (e.g., at the server computer(s) 102). The media platform 104 receives, over a network 150, indication of the selection to the UI element 166, and the prompt generator 158 generates the prompt 130 for use as an input to the ML model 120.

The media application 156 may transmit the prompt 130 to a ML model 120. In some examples, the ML model 120 is stored on the server computer(s) 102, which also executes the media platform 104. In some examples, the ML model 120 is stored on one or more server computers that are different from the server computer(s) 102 that execute the media platform 104. In some examples, the media platform 104 receives the prompt 130 and then transmits the prompt 130 to the ML model 120. In some examples, the ML model 120 is stored (e.g., stored locally) on the display device 152. In some examples, the ML model 120 is included as part of the operating system 151. In response to the prompt 130, the ML model 120 may generate the textual summary 126 using the subtitle data 124. In some examples, the ML model 120 includes a large language model (LLM) 122. In some examples, the LLM 122 is a conventional large language model (e.g., based on a transformer architecture), adapted to generate text in response to a text prompt provided as input. Such LLMs are trained on a large corpus of publicly available text, e.g., content from public databases and websites.

The LLM 122 may include any type of pre-trained large language model (LLM) configured to generate textual summaries 126 in a media content item 108 in response to a prompt 130. The LLM 122 includes weights, where the weights are numerical parameters that the LLM 122 learns during the training process. The weights are used to compute the output (e.g., the prompt response 132) of the LLM 122. In some examples, the LLM 122 includes a pre-trained language model that has been fine-tuned with additional training data (e.g., media content items 108) to generate textual summaries 126 in different types of media content 106.

The LLM 122 may receive text input, where the text input includes the prompt 130. The LLM 122 may include a pre-processing engine configured to pre-process the text input. Pre-processing may include converting the text input to individual tokens (e.g., words, phrases, or characters). Pre-processing may include other operations such as removing stop words (e.g., “the”, “and”, “of”) or other terms or syntax that do not impart any meaning to the LLM 122. The LLM 122 includes an embedding engine configured to generate word embeddings from the pre-processed text input. The word embeddings may be vector representations that assist the LLM 122 to capture the semantic meaning of the input tokens and may assist the LLM 122 to better understand the relationships between the input tokens. The LLM 122 includes a neural network(s) configured to receive the word embeddings and generate an output.

A neural network includes multiple layers of interconnected neurons (e.g., nodes). The neural network may include an input layer, one or more hidden layers, and an output later. The output may include a sequence of output word probability distributions, where each output distribution represents the probability of the next word in the sequence given the input sequence so far. In some examples, the output may be represented as a probability distribution over the vocabulary or a subset of the vocabulary. The neural network(s) is configured to receive the word embeddings and generate an output, and, in some examples, the query activity (e.g., previous natural language queries 168 and prompt responses 132). The output may represent a version of the textual response. The output may include a sequence of output word probability distributions, where each output distribution represents the probability of the next word in the sequence given the input sequence so far. In some examples, the output may be represented as a probability distribution over the vocabulary or a subset of the vocabulary. The decoder is configured to receive the output and generate the textual summary 126 of a media content item 108. In some examples, the decoder may select the most likely instruction, sampling from a probability distribution, or using other techniques to generate coherent and valid source code. The LLM 122 includes a decoder configured to receive the output and generate a prompt response 132 with the textual summary 126.

The ML model 120 generates and transmits a prompt response 132 with the textual summary 126. In some examples, the prompt response 132 includes information in JSON notation. In response to receiving the prompt response 132 or the textual summary 126, the media application 156 may display the textual summary 126 on the user interface 164. In some examples, the media content item 108 is paused, and the textual summary 126 is displayed on the user interface 164. In some examples, the textual summary 126 is displayed in a UI object. In some examples, the textual summary 126 (e.g., the UI object with the textual summary 126) is overlaid on a current (paused) image frame of the media content item 108. In some examples, in response to closing the UI object with the textual summary 126, playback of the media content item 108 is resumed.

The media platform 104 may store user accounts 110, where each user account 110 stores information about a respective user. A user account 110 may store entitlement data 112 and/or user activity information 114. The entitlement data 112 includes information that identifies which providers (e.g., streaming platforms 128, streaming applications 154) that the user account 110 has access rights to view content. In some examples, the access rights are determined based on the user account 110 (e.g., whether the user has subscribed to one or more streaming applications 154), which streaming applications 154 are installed on the display device 152 and/or if the user has accessed (e.g., logged-into) a user account associated with those streaming applications 154. In response to certain user activity regarding media content items 108, the media platform 104 may update the user activity information 114 with information about the activity such as a content identifier 135, the date/time, and/or the watch duration of the media content item 108, etc.

The display device 152 includes one or more processors, one or more memory devices, and an operating system 151 configured to execute (or assist with executing) one or more streaming applications 154. The one or more memory devices may be a non-transitory computer-readable medium storing executable instructions that cause the one or more processors to execute operations discussed herein. The display device 152 may be any type of user device. In some examples, the display device 152 is a television device (e.g., a smart television). In some examples, the display device 152 is a smartphone, a laptop computer, a desktop computer, a gaming console, and/or a wearable device such as a head-mounted display device. In some examples, the display device 152 is an augmented reality (AR) or virtual reality (VR) device. The streaming applications 154 may include a media application 156 configured to communicate, over the network, 150, with a media platform 104 executable by one or more server computers 102. In some examples, the media application 156 is a program that is part of the operating system 151. In some examples, the media application 156 is a separate standalone application that is downloaded and installed on the operating system 151. In some examples, the media application 156 may execute operation(s) discussed with reference to the operating system 151 (and/or vice versa). In some examples, the display device 152 is not a smart television, but is converted to a smart television when connected to a casting device, where the casting device is configured to connect to the network 150 and execute an operating system 151 configured to execute streaming applications 154, including the media application 156.

In some examples, the operating system 151 is a browser application. A browser application is a web browser configured to access information on the Internet and may launch one or more browser tabs in the context of one or more browser windows. In some examples, the operating system 151 is a Linux-based operating system. In some examples, the operating system 151 is a mobile operating system that is also configured to execute on smaller devices (e.g., smartphones, tablets, wearables, etc.).

The server computer 102 may be computing devices that take the form of a number of different devices, for example a standard server, a group of such servers, or a rack server system. In some examples, the server computer 102 may be a single system sharing components such as processors and memories. The network 150 may include the Internet and/or other types of data networks, such as a local area network (LAN), a wide area network (WAN), a cellular network, satellite network, or other types of data networks. The network 150 may also include any number of computing devices (e.g., computer, servers, routers, network switches, etc.) that are configured to receive and/or transmit data within network 150. Network 150 may further include any number of hardwired and/or wireless connections.

The server computer 102 may include one or more processors formed in a substrate, an operating system (not shown) and one or more memory devices. The memory devices may represent any kind of (or multiple kinds of) memory (e.g., RAM, flash, cache, disk, tape, etc.). In some examples (not shown), the memory devices may include external storage, e.g., memory physically remote from but accessible by the server computer 102. The server computer 102 may include one or more modules or engines representing specially programmed software.

FIG. 2A and 2B illustrate example user interfaces for generating and displaying a textual summary 226. The example user interfaces of FIGS. 2A and 2B may be examples of user interfaces (e.g., user interface 164 of FIG. 1) provided by the system 100 of FIG. 1. As shown in FIG. 2A, a media application may render a user interface 264 with a media content item that is currently playing. The user interface 264 includes a UI element 266, which, when selected, causes the system to display a textual summary 226, as shown in FIG. 2B, according to the techniques described in FIG. 1.

FIG. 3 is a flowchart 300 depicting example operations of a system that generates and displays a textual summary using a ML model according to an aspect. The flowchart 300 may depict operations of a computer-implemented method. The flowchart 300 may depict operations of a non-transitory computer-readable medium having executable instructions that when executed by one or more processors cause the one or more processors to execute the operations of the flowchart 300. Although the flowchart 300 is explained with respect to the system 100 of FIG. 1, the flowchart 300 may be applicable to any of the implementations discussed herein. Although the flowchart 300 of FIG. 3 illustrates the operations in sequential order, it will be appreciated that this is merely an example, and that additional or alternative operations may be included. Further, operations of FIG. 3 and related operations may be executed in a different order than that shown, or in a parallel or overlapping fashion.

Operation 302 includes initiating display of a media content item on a user interface displayed on a display device, the user interface including a user interface (UI) element. Operation 304 includes, in response to a selection of the UI element, pausing playback of the media content item. Operation 306 includes obtaining subtitle data for a portion of the media content item. Operation 308 includes generating a prompt request with a request to generate a textual summary by a machine-learning (ML) model using the subtitle data. Operation 310 includes receiving, from the ML model, a prompt response that includes the textual summary. Operation 312 includes displaying the textual summary on the user interface.

Clause 1. A method comprising: initiating display of a media content item on a user interface displayed on a display device, the user interface including a user interface (UI) clement; in response to a selection of the UI element, obtaining subtitle data for a portion of the media content item; generating a prompt request with a request to generate a textual summary by a machine-learning (ML) model using the subtitle data; receiving, from the ML model, a prompt response that includes the textual summary; and displaying a UI object with the textual summary on the user interface.

Clause 2. The method of clause 1, further comprising: in response to the selection of the UI element, pausing playback of the media content item.

Clause 3. The method of clause 2, further comprising: in response to closing the UI object, resuming playback of the media content item.

Clause 4. The method of clause 1, wherein the UI element is overlaid on video content of the media content item.

Clause 5. The method of clause 1, further comprising: receiving, via the user interface, a natural language query about the media content item; receiving, in response to the natural language query, a textual response from the ML model; and displaying the textual response on the user interface.

Clause 6. The method of clause 1, further comprising: obtaining one or more signals about a user account; and generating the prompt request to include information from the one or more signals about the user account, wherein the textual summary is a summary personalized to the user account.

Clause 7. The method of clause 1, further comprising: providing a plurality of media content items for selection on the user interface, the plurality of media content items associated with a plurality of streaming platforms; and in response to selection of the media content item from the plurality of media content items, streaming the media content item from a respective streaming platform.

Clause 8. The method of clause 1, further comprising: generating, by an image-to-text model, textual data about image frames for the portion of the media content item by inputting the image frames to the image-to-text model; and generating, by the ML model, the textual summary based on the textual data.

Clause 9. A display device comprising: at least one processor; and a non-transitory computer-readable medium storing executable instructions that when executed by the at least one processor cause the at least one processor to: initiate display of a media content item on a user interface displayed on a display device, the user interface including a user interface (UI) element; in response to a selection of the UI element, obtain subtitle data for a portion of the media content item; generate a prompt request with a request to generate a textual summary by a machine-learning (ML) model using the subtitle data; receive, from the ML model, a prompt response that includes the textual summary; and display a UI object with the textual summary on the user interface.

Clause 10. The display device of clause 9, wherein the executable instructions include instructions that cause the at least one processor to: in response to the selection of the UI element, pause playback of the media content item.

Clause 11. The display device of clause 10, wherein the executable instructions include instructions that cause the at one processor to: in response to closing the UI object, resume playback of the media content item.

Clause 12. The display device of clause 9, wherein the UI element is overlaid on video content of the media content item.

Clause 13. The display device of clause 9, wherein the executable instructions include instructions that cause the at one processor to: receive, via the user interface, a natural language query about the media content item; receive, in response to the natural language query, a textual response from the ML model; and display the textual response on the user interface.

Clause 14. The display device of clause 9, wherein the executable instructions include instructions that cause the at one processor to: obtain one or more signals about a user account; and generate the prompt request to include information from the one or more signals about the user account, wherein the textual summary is a summary personalized to the user account.

Clause 15. The display device of clause 9, wherein the executable instructions include instructions that cause the at one processor to: provide a plurality of media content items for selection on the user interface, the plurality of media content items associated with a plurality of streaming platforms; and in response to selection of the media content item from the plurality of media content items, stream the media content item from a respective streaming platform.

Clause 16. The display device of clause 9, wherein the executable instructions include instructions that cause the at one processor to: generate, by an image-to-text model, textual data about image frames for the portion of the media content item by inputting the image frames to the image-to-text model; and generate, by the ML model, the textual summary based on the textual data.

Clause 17. A non-transitory computer-readable medium storing executable instructions that when executed by at least one processor cause the at least one processor to execute operations, the operations comprising: initiating display of a media content item on a user interface displayed on a display device, the user interface including a user interface (UI) element; in response to a selection of the UI element, obtaining subtitle data for a portion of the media content item; generating a prompt request with a request to generate a textual summary by a machine-learning (ML) model using the subtitle data; receiving, from the ML model, a prompt response that includes the textual summary; and displaying a UI object with the textual summary on the user interface.

Clause 18. The non-transitory computer-readable medium of clause 17, wherein the operations further comprise: in response to the selection of the UI element, pausing playback of the media content item; and in response to closing the UI object, resuming playback of the media content item.

Clause 19. The non-transitory computer-readable medium of clause 17, wherein the UI element is overlaid on video content of the media content item.

Clause 20. The non-transitory computer-readable medium of clause 17, wherein the operations further comprise: receiving, via the user interface, a natural language query about the media content item; receiving, in response to the natural language query, a textual response from the ML model; and displaying the textual response on the user interface.

Various implementations of the systems and techniques described here can be realized in digital electronic circuitry, integrated circuitry, specially designed ASICS (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are remote from each other and typically interact through a communication network. The relationship of client and server arises by virtue of computer programs running on the respective computers and having a client-server relationship with each other.

In this specification and the appended claims, the singular forms “a,” “an” and “the” do not exclude the plural reference unless the context clearly dictates otherwise. Further, conjunctions such as “and,” “or,” and “and/or” are inclusive unless the context clearly dictates otherwise. For example, “A and/or B” includes A alone, B alone, and A with B. Further, connecting lines or connectors shown in the various figures presented are intended to represent example functional relationships and/or physical or logical couplings between the various elements. Many alternative or additional functional relationships, physical connections or logical connections may be present in a practical device. Moreover, no item or component is essential to the practice of the implementations disclosed herein unless the element is specifically described as “essential” or “critical”.

Terms such as, but not limited to, approximately, substantially, generally, etc. are used herein to indicate that a precise value or range thereof is not required and need not be specified. As used herein, the terms discussed above will have ready and instant meaning to one of ordinary skill in the art.

Moreover, use of terms such as up, down, top, bottom, side, end, front, back, etc. herein are used with reference to a currently considered or illustrated orientation. If they are considered with respect to another orientation, it should be understood that such terms must be correspondingly modified.

Although certain example methods, apparatuses and articles of manufacture have been described herein, the scope of coverage of this patent is not limited thereto. It is to be understood that terminology employed herein is for the purpose of describing particular aspects and is not intended to be limiting. On the contrary, this patent covers all methods, apparatus and articles of manufacture fairly falling within the scope of the claims of this patent.

What is claimed is:

1. A method comprising:
initiating display of a media content item on a user interface displayed on a display device, the user interface including a user interface (UI) element;
in response to a selection of the UI element, obtaining subtitle data for a portion of the media content item;
generating a prompt request with a request to generate a textual summary by a machine-learning (ML) model using the subtitle data;
receiving, from the ML model, a prompt response that includes the textual summary; and
displaying a UI object with the textual summary on the user interface.

2. The method of claim 1, further comprising:
in response to the selection of the UI element, pausing playback of the media content item.

3. The method of claim 2, further comprising:
in response to closing the UI object, resuming playback of the media content item.

4. The method of claim 1, wherein the UI element is overlaid on video content of the media content item.

5. The method of claim 1, further comprising:
receiving, via the user interface, a natural language query about the media content item;
receiving, in response to the natural language query, a textual response from the ML model; and
displaying the textual response on the user interface.

6. The method of claim 1, further comprising:
obtaining one or more signals about a user account; and
generating the prompt request to include information from the one or more signals about the user account, wherein the textual summary is a summary personalized to the user account.

7. The method of claim 1, further comprising:
providing a plurality of media content items for selection on the user interface, the plurality of media content items associated with a plurality of streaming platforms; and
in response to selection of the media content item from the plurality of media content items, streaming the media content item from a respective streaming platform.

8. The method of claim 1, further comprising:
generating, by an image-to-text model, textual data about image frames for the portion of the media content item by inputting the image frames to the image-to-text model; and
generating, by the ML model, the textual summary based on the textual data.

9. A display device comprising:
at least one processor; and
a non-transitory computer-readable medium storing executable instructions that when executed by the at least one processor cause the at least one processor to:
initiate display of a media content item on a user interface displayed on a display device, the user interface including a user interface (UI) element;
in response to a selection of the UI element, obtain subtitle data for a portion of the media content item;
generate a prompt request with a request to generate a textual summary by a machine-learning (ML) model using the subtitle data;
receive, from the ML model, a prompt response that includes the textual summary; and
display a UI object with the textual summary on the user interface.

10. The display device of claim 9, wherein the executable instructions include instructions that cause the at one processor to:
in response to the selection of the UI element, pause playback of the media content item.

11. The display device of claim 10, wherein the executable instructions include instructions that cause the at one processor to:
in response to closing the UI object, resume playback of the media content item.

12. The display device of claim 9, wherein the UI element is overlaid on video content of the media content item.

13. The display device of claim 9, wherein the executable instructions include instructions that cause the at one processor to:
receive, via the user interface, a natural language query about the media content item;
receive, in response to the natural language query, a textual response from the ML model; and
display the textual response on the user interface.

14. The display device of claim 9, wherein the executable instructions include instructions that cause the at one processor to:
obtain one or more signals about a user account; and
generate the prompt request to include information from the one or more signals about the user account, wherein the textual summary is a summary personalized to the user account.

15. The display device of claim 9, wherein the executable instructions include instructions that cause the at one processor to:
provide a plurality of media content items for selection on the user interface, the plurality of media content items associated with a plurality of streaming platforms; and
in response to selection of the media content item from the plurality of media content items, stream the media content item from a respective streaming platform.

16. The display device of claim 9, wherein the executable instructions include instructions that cause the at one processor to:
generate, by an image-to-text model, textual data about image frames for the portion of the media content item by inputting the image frames to the image-to-text model; and
generate, by the ML model, the textual summary based on the textual data.

17. A non-transitory computer-readable medium storing executable instructions that when executed by at least one processor cause the at least one processor to execute operations, the operations comprising:
initiating display of a media content item on a user interface displayed on a display device, the user interface including a user interface (UI) element;
in response to a selection of the UI element, obtaining subtitle data for a portion of the media content item;
generating a prompt request with a request to generate a textual summary by a machine-learning (ML) model using the subtitle data;
receiving, from the ML model, a prompt response that includes the textual summary; and
displaying a UI object with the textual summary on the user interface.

18. The non-transitory computer-readable medium of claim 17, wherein the operations further comprise:
in response to the selection of the UI element, pausing playback of the media content item; and
in response to closing the UI object, resuming playback of the media content item.

19. The non-transitory computer-readable medium of claim 17, wherein the UI element is overlaid on video content of the media content item.

20. The non-transitory computer-readable medium of claim 17, wherein the operations further comprise:
receiving, via the user interface, a natural language query about the media content item;
receiving, in response to the natural language query, a textual response from the ML model; and
displaying the textual response on the user interface.
